(19) United States
(12) Patent Application Publication
(10) Pub. No.: US 2019/0370038 A1
(43) Pub. Date: Dec. 5, 2019

(54) APPARATUS AND METHOD SUPPORTING CODE OPTIMIZATION

(71) Applicant: Intel Corporation, Santa Clara, CA (US)

(72) Inventors: Micah VILLMOW, Santa Clara, CA (US); Kevin LAWTON, Santa Clara, CA (US); Ravishankar RAO, Redwood City, CA (US); Mohammad A. ABDALLAH, Folsom, CA (US)

(21) Appl. No.: 16/313,836

(22) PCT Filed: Jul. 24, 2017
(86) PCT No.: PCT/US2017/043558

§ 371 Date: Dec. 27, 2018

Related U.S. Application Data
(60) Provisional application No. 62/367,537, filed on Jul. 27, 2016.

(51) Int. Cl. G06F 9/455; G06F 9/30

(52) U.S. Cl. CPC G06F 9/4552; G06F 9/30174; G06F 9/30043

(57) ABSTRACT

An apparatus and method for providing support for execution of optimized code. The apparatus includes a processor that is configured to convert guest code to native code and monitor access to an indicated memory address range associated with a read-only portion of the memory and to detect access to the indicated memory address range. The processor is further configured to raise an exception in response to memory access to the indicated memory address range and determine an access property of the indicated memory address range.

### CROSS-REFERENCE TO RELATED APPLICATIONS

This application claims the benefit of U.S. Provisional Application No. 62/367,537, filed 27 Jul. 2016, which is hereby incorporated by reference.

### TECHNICAL FIELD

Embodiments of the invention relate to the field of optimized execution of non-native instructions; and more specifically, to optimized code execution in environments that involve multi-threaded execution, out of order execution, or a debugger.

### BACKGROUND

Many types of digital computer systems utilize code transformation/translation or emulation to implement software-based functionality. Generally, translation and emulation both involve examining a program of software instructions and performing the functions and actions dictated by the software instructions, even though the instructions are not “native” to the computer system. In the case of translation, the non-native instructions are translated into native instructions which are designed to execute on the hardware of the computer system. Examples include translation software and/or hardware that operates with industry standard x86 applications to enable the applications to execute on non-x86 or alternative computer architectures. Generally, a translation process utilizes a large number of processor cycles, and thus, imposes a substantial amount of overhead. The performance penalty imposed by the overhead can substantially erode any benefits provided by the translation process.

One attempt at solving this problem involves the use of just-in-time compilation. Just-in-time compilation (JIT), also known as dynamic translation, is a method to improve the runtime performance of computer programs. Traditionally, computer programs had two modes of runtime transformation, either interpretation mode or JIT (Just-In-Time) compilation/translation mode. Interpretation is a decoding process that involves decoding instruction by instruction to transform the code from non-native (or guest) to native with lower overhead than JIT compilation, but it produces transformed code that has less performance. Additionally, the interpretation is invoked with every instruction. JIT compilers or translators represent a contrasting approach to interpretation. JIT conversion usually has a higher overhead than interpreters, but it produces translated code that is more optimized and one that has higher execution performance. In most emulation implementations, the first time a translation is encountered, it is interpreted to reduce overhead, after the code is seen (executed) many times, the JIT's invoked to create a more optimized translation. The JIT optimized translation can have issues when used in a multi-threaded environment.

### BRIEF DESCRIPTION OF THE DRAWINGS

The invention may best be understood by referring to the following description and accompanying drawings that are used to illustrate embodiments of the invention. In the drawings:

FIG. 1 is a diagram depicting one embodiment of a block-based translation process where guest instruction blocks are converted to native conversion blocks.

FIG. 2 is a diagram of one embodiment of example code segment diagram.

FIG. 3 is a dataflow diagram for one example embodiment of an optimized single thread execution in a single threaded environment.

FIG. 4 is a dataflow diagram for one example embodiment of invalidly optimized single thread execution in a multi-threaded environment.

FIG. 5A is a dataflow diagram for one example embodiment of correctly optimized single thread execution in a multi-threaded environment.

FIG. 5B is a further dataflow diagram for one example embodiment of correctly optimized single thread execution in a multi-threaded environment.

FIG. 6 is a flowchart of an example embodiment of an electronic component controlled process for executable code generation.

FIG. 7 is a diagram of one embodiment of example components of generated executable code.

FIG. 8A is a flowchart of one embodiment of an example electronic component controlled process for enabling range protection.

FIG. 8B is a flowchart of one embodiment of an example electronic component controlled process for preforming verification.

FIG. 9 is a block diagram of an example computing system including various embodiments.

FIG. 10A is a block diagram illustrating both an example in-order pipeline and an example register renaming, out-of-order issue/execution pipeline according to embodiments of the disclosure.

FIG. 10B is a block diagram illustrating both an example embodiment of an in-order architecture core and an example register renaming, out-of-order issue/execution architecture core to be included in a processor according to embodiments of the disclosure.

FIG. 11A is a block diagram of a single processor core, along with its connection to the on-die interconnect network and with its local subset of the Level 2 (L2) cache, according to embodiments of the disclosure.

FIG. 11B is an expanded view of part of the processor core in FIG. 11A according to embodiments of the disclosure.

FIG. 12 is a block diagram of a processor that may have more than one core, may have an integrated memory controller, and may have integrated graphics according to embodiments of the disclosure.

FIG. 13 is a block diagram of a system in accordance with one embodiment of the present disclosure.

FIG. 14 is a block diagram of a more specific example system in accordance with an embodiment of the present disclosure.

FIG. 15, shown is a block diagram of a second more specific example system in accordance with an embodiment of the present disclosure.

FIG. 16, shown is a block diagram of a system on a chip (SoC) in accordance with an embodiment of the present disclosure.

FIG. 17 is a block diagram contrasting the use of a software instruction converter to convert binary instructions in a source instruction set to binary instructions in a target instruction set according to embodiments of the disclosure.

### DETAILED DESCRIPTION

The embodiments provide a system and method to handle optimized code execution in environments that involve multi-threaded execution, out of order execution, or a debugger. Embodiments can include a memory protection mechanism that tracks memory access within an address range (e.g., a memory page), ordering of loads relative to the enabling of the memory protection mechanism, debugger support, replacement of loads with constants (e.g., values from read-only memory), propagation of the constants to optimize code, and verification of values accessed during translation thereby improving performance and providing correctness.

An embodiment is implemented as an apparatus for providing support for execution of optimized code. The apparatus includes a memory and a processor. The processor is configured to convert guest code to native code and monitor access to an indicated memory address range associated with a read-only portion of the memory and to detect access to the indicated memory address range. The processor is further configured to raise an exception in response to memory access to the indicated memory address range and determine an access property of the indicated memory address range.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined by the claims, will be apparent in the non-limiting detailed description set forth below to one skilled in the art.

In the following detailed description, numerous specific details such as specific method orders, structures, elements, and connections have been set forth. It is to be understood however that these and other specific details need not be utilized to practice embodiments of the present invention. In other circumstances, well-known structures, elements, or connections have been omitted, or have not been described in particular detail in order to avoid unnecessarily obscuring this description.

References within the specification to “one embodiment” or “an embodiment” are intended to indicate that a particular feature, structure, or characteristic described in connection with the embodiment is included in at least one embodiment of the present invention. The appearance of the phrase “in one embodiment” in various places within the specification are not necessarily all referring to the same embodiment, nor are separate or alternative embodiments mutually exclusive of other embodiments. It is noted that any claimed embodiment does not necessarily include all of the “objects” or “embodiments” of the disclosure.

Moreover, various features are described which may be exhibited by some embodiments and not by others. Similarly, various requirements are described which may be requirements for some embodiments but not other embodiments.

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals of a computer readable storage medium and are capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing,” “accessing,” “writing,” “storing,” “starting,” or “triggering,” “analyzing,” “propagating,” “enabling,” “generating,” “outputting,” “executing” or the like, refer to the action and processes of a computer system, or similar electronic computing device that manipulates and transforms data represented as physical (electronic) quantities within the computer system's registers and memories and other computer readable media into other data similarly represented as physical quantities within the computer system memories or registers or other such information storage, transmission or display devices.

Reference will now be made in detail to the various embodiments of the present disclosure, examples of which are illustrated in the accompanying drawings. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments can include a memory protection mechanism that tracks memory access within an address range (e.g., a memory page), ordering of loads relative to the enabling of the memory protection mechanism, debugger support, replacement of loads with constants (e.g., values from read-only memory), propagation of the constants to optimize code, and verification of values accessed during translation thereby improving performance and providing correctness.

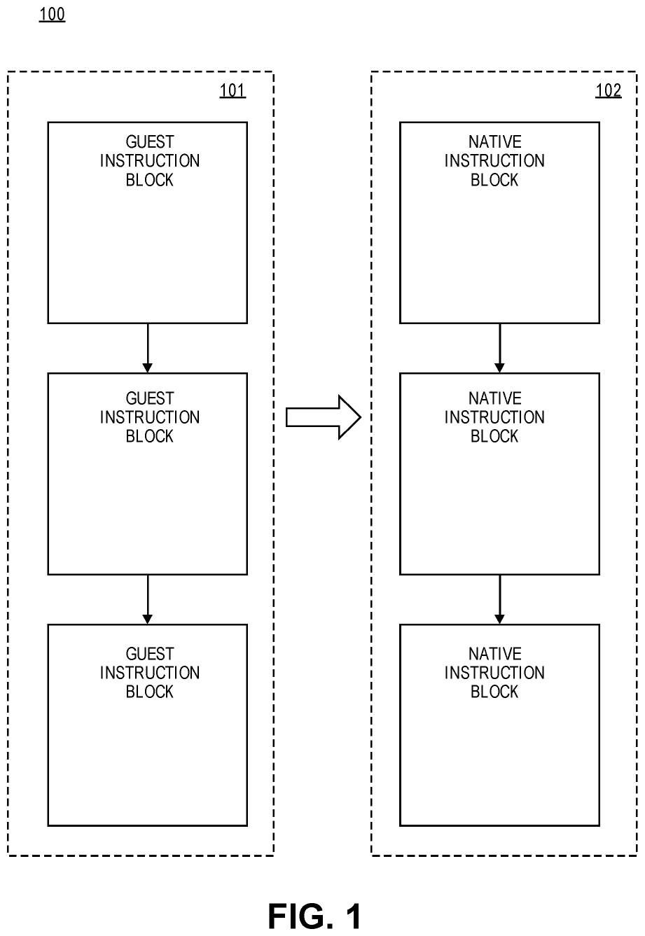

FIG. 1 shows a diagram depicting a block-based conversion process, where guest instruction blocks are converted to native conversion blocks, in accordance with various embodiments. As illustrated in FIG. 1, a plurality of guest instruction blocks 101 are shown being converted to a corresponding plurality of native conversion blocks 102.

Each of the blocks 101 are made up of guest instructions. These guest instructions can be from a number of different guest instruction architectures (e.g., Java, JavaScript, x86, MIPS, SPARC, etc.). Multiple guest instruction blocks can be converted into one or more corresponding native conversion blocks. This conversion can occur on a per instruction basis.

A program can include multiple load instructions to retrieve data from memory and store instructions to store data to memory. Often, the data can come from a section of memory that to the current instance of the program is not write-able. This memory section can be treated as read-only memory. The read-only memory granularity can be at the page boundary with a preset number of contiguous bytes starting at an aligned location.

With dynamic binary translation, e.g., with a just-in-time (JIT) compiler, the software can optimize executing code using a trace based mechanism. During this optimization of the executing code, each of the loads can be examined for unique properties. A subset of the loads will have known addresses at runtime that can correspond directly to a location in memory.

A smaller subset of the loads will correspond to memory locations that are in read-only memory. The software can determine that the memory location is read-only by querying (e.g., the hardware) to ascertain the attributes of a specific page in memory to which the address belongs. If the memory location is read-only and the address is known, then the compiler can read the data and inline the data (e.g., a value) into the executing code. This can cause more addresses to become known and propagated throughout the program allowing the compiler to optimize the code in a way that a normal compiler would not be able to (e.g., an ahead of time (AOT) compiler).

The Figures illustrate example components used by various embodiments. Although specific components are disclosed in the Figures, it should be appreciated that such components are provide by way of example and not limitation. The embodiments would be understood by one skilled in the art to encompass various other components or variations of the components recited in the Figures. It is appreciated that the components in the Figures may operate with other components than those presented, and that not all of the components of the Figures are required to achieve the goals of embodiments.

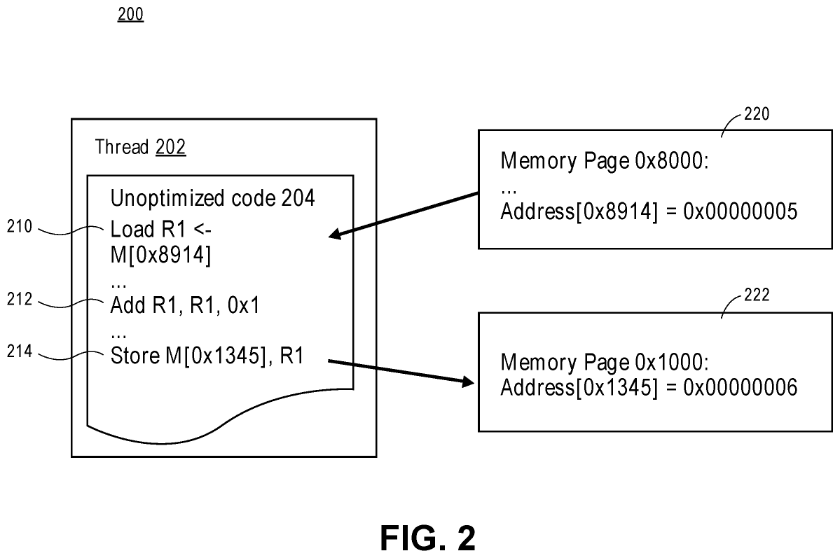

FIG. 2 shows an example code segment diagram, in accordance with various embodiments. FIG. 2 depicts an example code segment diagram 200 including an example thread 202 and associated memory pages 220-222. The example thread 202 comprises an unoptimized code segment 204 for execution in a single threaded environment or a multi-threaded environment.

The memory page 220 comprises addresses starting with 0x8000 and includes address 0x8914 which has a stored value of 0x00000005. The memory page 222 comprises addresses starting with 0x1000 and includes address 0x1345 which has a stored value of 0x00000006.

The unoptimized code segment 204 includes instructions 210-214. It is noted that there may be one or more instructions between the instructions 210-214 of the unoptimized code segment 204. The instruction 210 loads a value from memory address 0x8914 into register R1. The instruction 212 adds the value 0x1 to the value in register R1 and stores the value in register R1. The instruction 212 thus adds 0x5 and 0x1 and stores the result of 0x6 into register R1. The instruction 214 then stores the value in register R1 to the memory address 0x1345. The instruction 214 thus stores 0x6 into the memory address 0x1345.

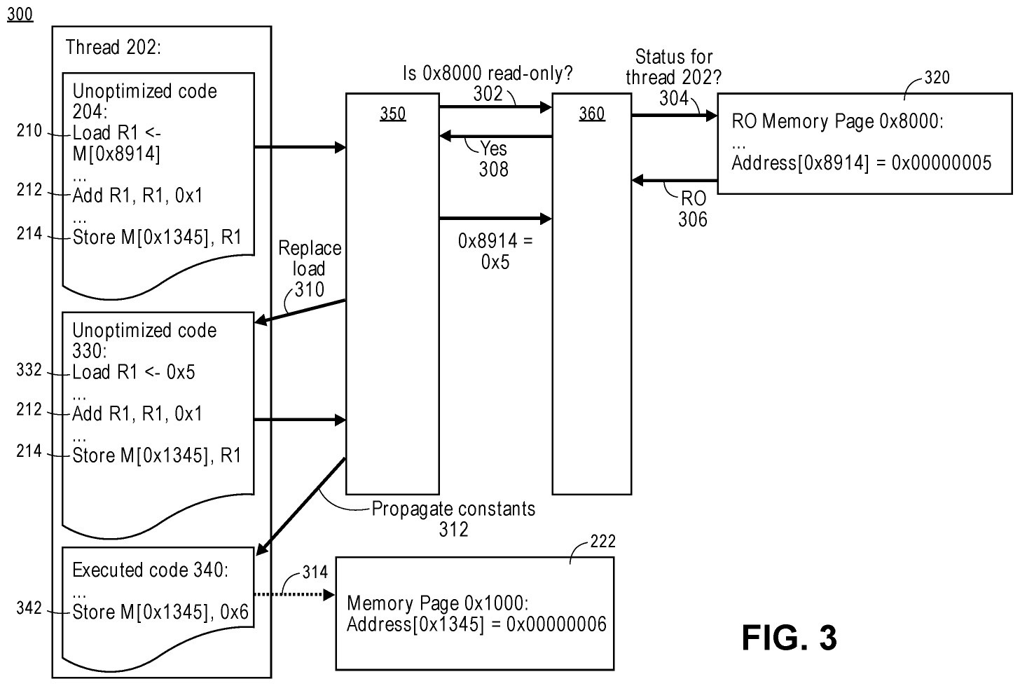

FIG. 3 shows an example dataflow diagram for optimized single thread execution in a single threaded environment, in accordance with various embodiments. FIG. 3 depicts the optimization of the thread 202 and the unoptimized code 204, the generation of optimized code 340, and execution of the optimized code 340. The example dataflow diagram 300 includes the thread 202, a compiler 350, a processor 360, and memory pages 222 and 320.

The compiler 350 may be a compiler that performs binary translation, e.g., a dynamic binary translation JIT compiler. The processor 360 may be a CPU or other type of processor.

The unoptimized code 204 is accessed by the compiler 350 (e.g., after execution of a program associated with thread 202 has started). The compiler 350 accesses the instruction 210 and determines if the instruction is a load instruction. Upon determining the instruction 210 is a load instruction, at step 302, the compiler 350 sends a request to the processor 360 to determine whether the page of memory of the load instruction is read-only, e.g., whether the memory page 0x8000 is read-only. Upon receiving the request from the compiler 350, the processor 360 determines whether the memory page is read-only for the thread 202. In one embodiment, at step 304, the processor 360 queries the memory to determine whether the status or access property of the memory page 320 is read-only.

In some embodiments, at step 306, the memory (e.g., memory controller) responds with an indication that the memory page 0x8000 is read-only. At step 308, the processor 360 responds to the request from the compiler 350 with an indication that the memory page 0x8000 is read-only. At step 310, the compiler 350 requests the value or data stored at the memory address of the load instruction 210 from the processor 360. The compiler 350 replaces the load instruction 210 with the load instruction 332 based on the value. The load instruction 332 loads the value 0x5 (e.g., received from the read-only memory address 0x8914) into the register R1. The compiler 350 thus inlines the value (e.g., 0x5) into the code 330. It is appreciated that load operations can be performance bottlenecks because of the time needed to access values from memory, e.g., a cache, RAM, or a virtual memory, and the inline of the values increases performance.

At step 312, the compiler 350 propagates the constants throughout the unoptimized code 330 to generate code 340. This can allow replacing several instructions with one or more instructions. For example, the instructions 332, 212, and 214 of unoptimized code 330 are replaced with the instruction 342 which is configured to store the value of 0x6 into memory address 0x1345. The value of 0x6 is determined based on the adding the value of 0x1 from instruction 212 to the value of 0x5 loaded into R1. The propagating of constants allows for removing latency associated with each removed instruction and any instructions dependent on a removed instruction can be executed parallel.

At step 314, the code 340 is executed and the value of 0x00000006 is stored at the memory address of 0x1345 of the memory page 0x1000.

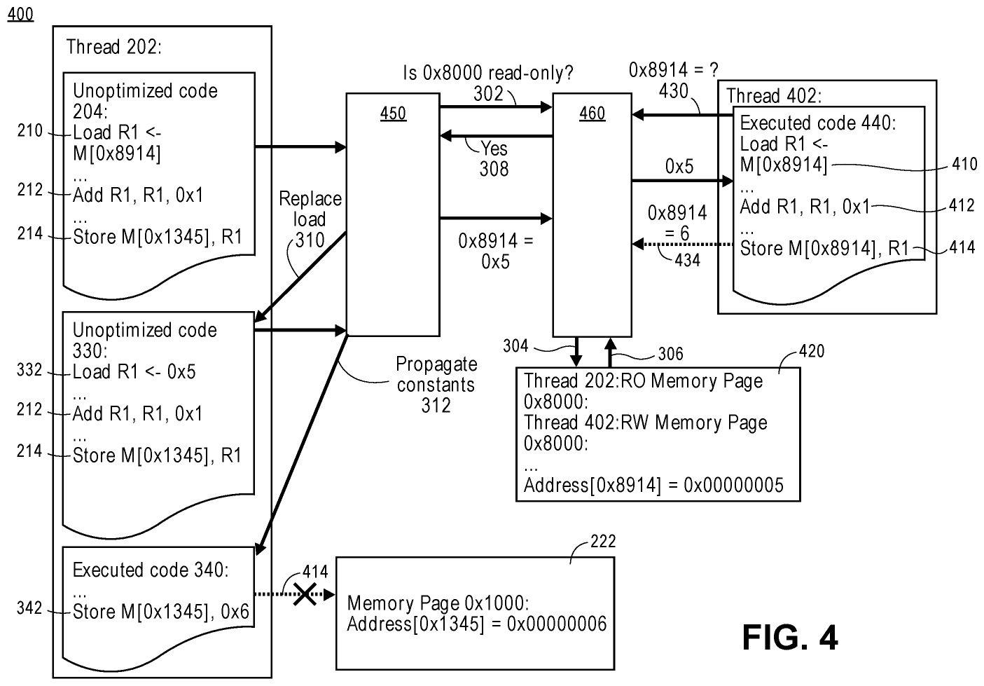

FIG. 4 shows an example dataflow diagram of invalidly optimized single thread execution in a multi-threaded environment. FIG. 4 depicts a dataflow diagram 400 of code optimization of a thread 202 which is performed in parallel with execution of a thread 402 which creates a race condition. The memory page 420 is read-only with respect to the thread 202 and the memory page 420 is read/write with respect to thread 402.

The dataflow diagram 400 includes similar dataflow steps of dataflow diagram 300. The thread 402 includes the code segment 440 which includes instructions 410-414. It is noted that there may be one or more instructions between the instructions 410-414 of the code segment 440. The instruction 410 loads a value from the memory address 0x8914 into a register R1. The instruction 412 adds the value 0x1 to the value in the register R1 and stores the value in the register R1. The instruction 412 thus adds 0x5 and 0x1 and stores the result of 0x6 into the register R1. The instruction 414 then stores the value in the register R1 to the memory address 0x8914. The instruction 414 thus stores the value 0x6 into memory at the memory address 0x8914.

The code segment 440 is executed after step 310, when the instruction 210 is replaced with the instruction 332. The value of 0x5 is thus inlined into the code 330 and code segment 440 is executed. At step 430, the instruction 410 loads the value of 0x5 from the memory address 0x8914 into the register R1. The instruction 412 adds 0x1 to the value in register R1 so that the register R1 has a value of 0x6. At step 434, the instruction 414 then stores the value 0x6 into the memory at memory address 0x8914.

At step 414, the code segment 340 to be executed which stores the value 0x6 to memory address 0x1345 instead of storing the value of 0x7 which would be correct based on the modification of the value at memory address 0x8914 by the thread 402. This race condition results in an incorrect value being stored.

Embodiments are configured to avoid the race condition described above. In the case where page attributes, e.g., read-only, read/write, are modified, the hardware, e.g., a processor, can notify the translation software, e.g., JIT compiler, and the optimized code is invalidated in order to preserve correctness. In embodiments where no more than one instance of a program can execute at a single time, this approach is sufficient enough to guarantee program correctness.

If more than a single program can execute at a single time, various problems arise. One problem that can arise is that the memory status of a given page can be different on a per-thread basis, as described. For example, a page may be read-only with respect to a first thread while the page is read/write with respect to a second thread.

Another problem is that in a multi-threaded environment, the side effects of loads need to be visible to other threads in the program. For example, a load operation of an invalid or protected address is unable throw an exception if the load operation has been removed during optimization of the code.

Another problem is that a debugger needs to be able to attach to memory accesses to a given address in order to monitor memory access and in response break and/or stop execution. For example, if a memory address is part of a watchpoint of a debugger, when a load or store is no longer present in optimized code, the watchpoint will not function to detect access to the memory address and the debugger will not be able to break when the memory address is accessed.

Another problem is caused by out of order execution by a processor. For example, if a load of a value from a memory address is removed during optimization but the value of the memory address is changed, then the correct value may not be loaded.

Embodiments solve the aforementioned problems, e.g., with a combination of software and hardware. In some embodiments, a processor includes a memory protection mechanism or functionality configured to track or monitor access to a range of memory addresses that are associated with read-only memory addresses. When the functionality detects memory access from an external client (e.g., another thread) to the protected memory addresses, an exception is raised so that software, e.g., a compiler, can invalidate the optimized code (e.g., speculatively optimized code). This functionality is further configured to detect if a debugger places a watchpoint on a memory address within the protected or monitored range, e.g., as the hardware keeps track of the watchpoint registers.

The memory protection functionality can further include supporting the specification (e.g., by the software or compiler) of how loads are ordered with respect to enabling of the memory protection mechanism. This is used because the memory protection functionality is configured to generate notifications of memory accesses to the protected memory region during the time when the memory protection functionality is enabled, however, memory could be changed outside of the time when the memory protection functionality is enabled and may not be detected correctly.

Embodiments may thus include a translator, e.g., a complier, configured to insert sanity checks into the program to verify that the speculative values of optimized code, e.g., values accessed from read-only memory, are correct. This may be done by loading the value from memory, e.g., from a memory address specified within the unoptimized code, and comparing it against an inlined value within optimized code. If the loaded value matches the inlined value, execution continues. If the loaded value does not match the inlined value, an exception is raised and the code segment is invalidated (e.g., in a substantially similar manner as if an external client has accessed the protected memory during execution), and the unoptimized code is executed instead.

Embodiments further support out of order execution devices. In an out of order processor, loads could possibly be executed before the memory protection functionality is activated. An ordering mechanism can be used (e.g., by the software) to inform the hardware (e.g., processor) that the current load is to be relatively ordered versus the memory protection functionality. The load itself my still execute out of order but is executed in order relative to the memory protection mechanism being enabled. Embodiments can thus include a memory protection mechanism that tracks memory access within an address range (e.g., a memory page), ordering of loads relative to the enabling of the memory protection mechanism, debugger support, replacement of loads with constants (e.g., values from read-only memory), propagation of the constants to optimize code, and verification of values accessed during translation thereby improving performance and providing correctness.

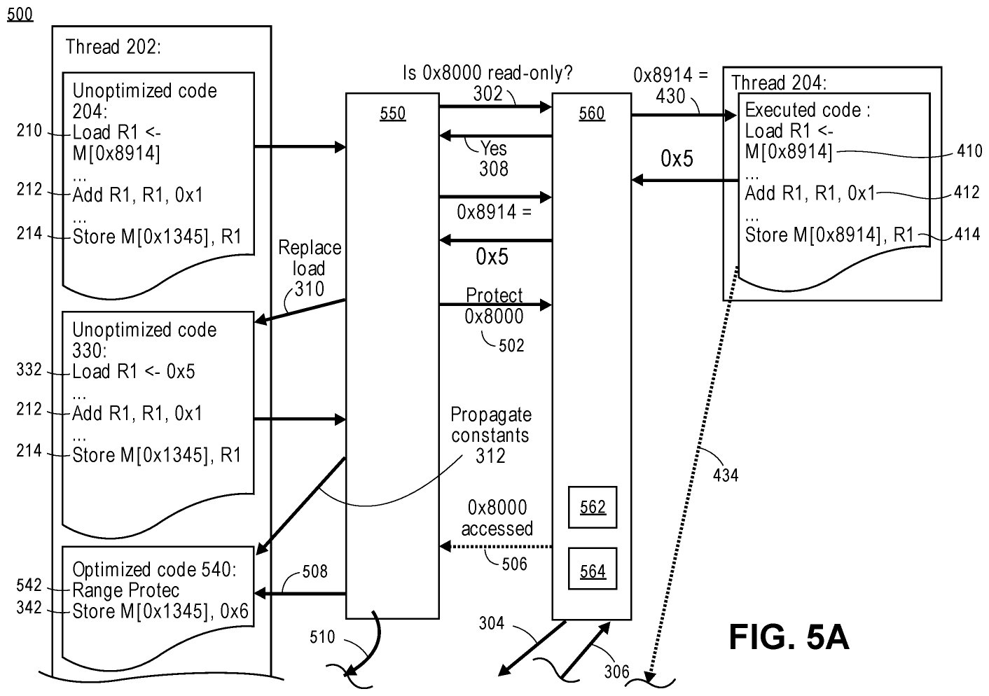

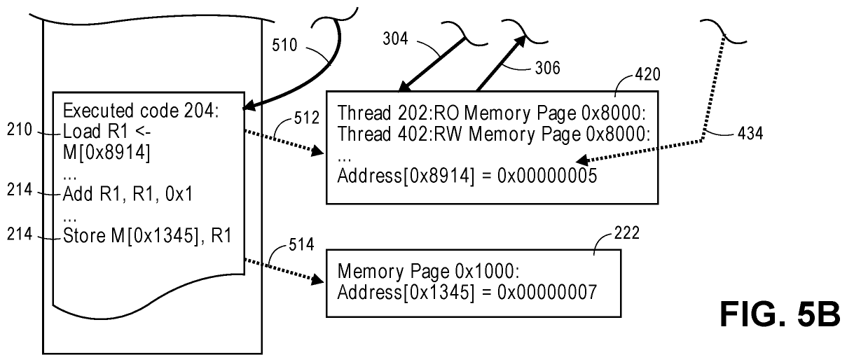

FIGS. 5A and 5B shows an example dataflow diagram of correctly optimized single thread execution in a multi-threaded environment, in accordance with various embodiments. FIGS. 5A and 5B depict a dataflow diagram 500 of code optimization of thread 202 which is performed in parallel with execution of a thread 402. The memory page 420 is read-only with respect to the thread 202 and the memory page 420 is read/write with respect to the thread 402.

The compiler 550 can include the features of the compiler 350 and further include functionality for generating optimized code with one or more range protect instructions, enabling of a memory protection (e.g., performed by a memory protection monitoring module 562 of a processor 560), and generating instructions for signaling an instruction ordering (e.g., performed by an ordering module 564). The one or more range protect instructions specify to a processor a memory range to that the processor (e.g., the processor 560) is to monitor access thereto.

The processor 560 can include the features of the processor 360 and further include functionality to receive a memory address range, e.g., memory page, monitor access to the memory address range, and signal the compiler when access to the memory range has been requested. For example, the processor 560 can receive an address range associated with a memory page (e.g., 0x8000) and monitor access to the memory page.

The dataflow diagram 500 includes similar dataflow steps as those of the dataflow diagram 400. The steps 302-312 are performed and the compiler 550 generates optimized code 540 which has loads replaced, constants propagated (e.g., values from read-only memory), and one or more range protect instructions. The optimized code 540 includes instructions 542 and 342. The instruction 542 may be one or more range protect instructions which specify a memory range for access monitoring by the processor 560. At step 502, the range protect instruction 542 is executed and the compiler 550 sends a signal to enable range protection on memory page 0x8000 to the processor 560. In some embodiments, the processor 550 may monitor read and write access for a given memory range in response to the one or more a range protect instructions.

In some embodiments, the processor 550 includes a memory protection monitoring module 562 and an ordering module 564. These modules 562 and 564 can be circuits implemented in the processor 550 or within any core of a multi-core processor. The protection monitoring module 562 is configured to receive a memory address or memory address range (e.g., from a compiler) for monitoring access thereto. The memory protection monitoring module 562 can be configured to monitor read and write access to a specified memory address range. The memory protection monitoring module 562 can act as a protection mechanism, as described herein, for any access to the memory range outside of a particular thread by notifying the compiler 550 of access to the memory. The ordering module 564 is configured to order loads relative to enabling of the protection mechanism or memory protection monitoring module 562. For example, the ordering module 564 can ensure that a load instruction is performed in order relative to a range protection instruction (e.g., that enables range protection or monitoring by the memory protection monitoring module 562).

The processor 560 executes thread 204 and performs instructions 410-414. The steps 430 and 434 are performed and the value stored at the memory address 0x8914 is changed to 0x00000006.

At step 506, the processor 560 signals the complier 550 the memory range of the memory page 0x8000 has been accessed. At step 508, the compiler 550 invalidates the optimized code 540. At step 510, the compiler 550 replaces the optimized code 540 with the unoptimized code 204. This thereby allows the correct value, e.g., 0x00000006, to be accessed by the load instruction 210 of the code 204.

In some embodiments, the compiler 550 is configured to execute atomic code sequences such that upon an exception occurring, e.g., notification of memory access within a protected range, a code segment, e.g., the optimized code 540, is backed out and replaced with appropriate code as determined by the compiler 550, e.g., the unoptimized code 204. Embodiments thus support transactional execution blocks.

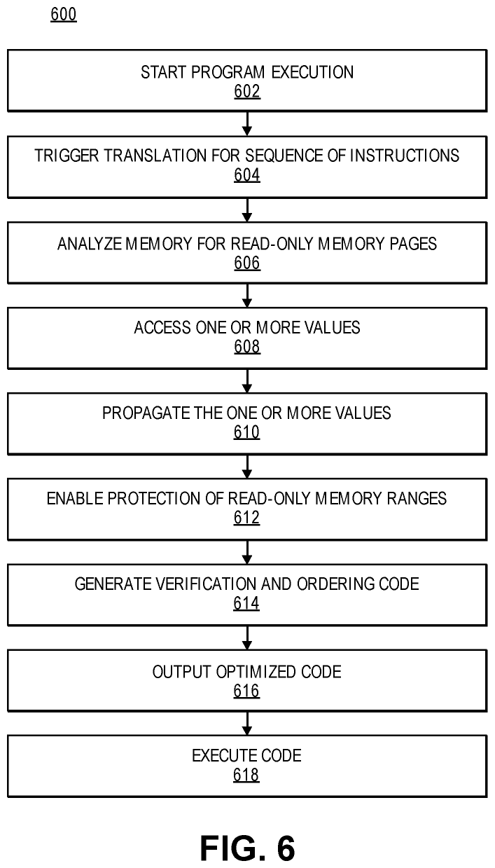

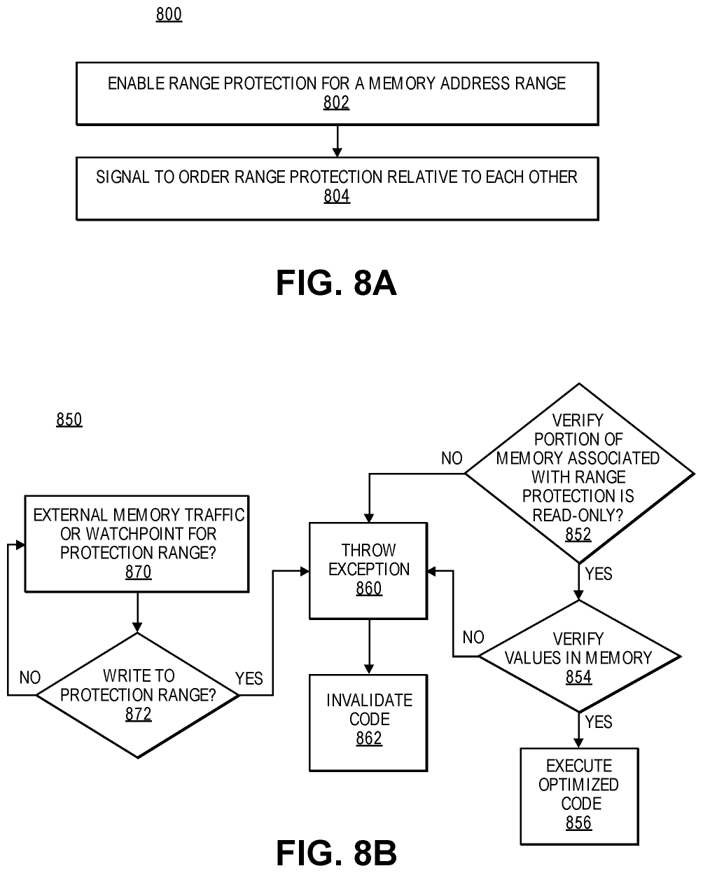

With reference to FIGS. 6 and 8A-B, flowcharts 600 and 800-850 illustrates example functions used by various embodiments for protecting data, as described herein. Although specific function blocks (“blocks”) are disclosed in flowcharts 600 and 800-850, such steps are example. That is, embodiments are well suited to performing various other blocks or variations of the blocks recited in flowcharts 600 and 800-850. It is appreciated that the blocks in flowcharts 600 and 800-850 can be performed in an order different than presented, and that not all of the blocks in flowcharts 600 and 800-850 need be performed.

FIG. 6 shows a flowchart of an example electronic component controlled process for executable code generation, in accordance with various embodiments FIG. 6 depicts a flowchart 600 of code generation by a compiler, e.g., compiler 550, during execution of a program.

At block 602, a program is executed. The program may include code that is stored in guest code and is to be translated into native code by a translator, e.g., a dynamic binary translator such as a JIT compiler, for execution.

At block 604, translation is triggered for a sequence of instructions. The sequence of instructions may be chunk of code based on a transactional model. The sequence of instructions may be a portion of a code (e.g., the code 204) of a thread (e.g., the thread 202) of a program. In some embodiments, the translation is performed by a JIT compiler (e.g., the compiler 550). The sequence of instructions may be translated to native code and then processed as described with respect to the following blocks.

At block 606, the sequence of instructions is analyzed for access to (e.g., a load instruction) read-only portion of memory. In some embodiments, the JIT compiler queries a processor to determine whether a particular memory page is read-only with respect to a thread associated with the code being processed by the JIT compiler.

At block 608, one or more values stored at the memory addresses in the read-only portion of memory are accessed. The values may be stored and then inlined into the code, as described herein.

At block 610, one or more values are propagated throughout the code. The propagation of the values throughout the code can be used to optimize the code by removing one or more load instructions and other instructions, e.g., add, subtract, multiply, divide, etc., and replacing the removed instructions with one or more store instructions.

At block 612, protection is enabled for the read-only memory range. In some embodiments, a processor component (e.g., memory protection monitoring module 542) may be signaled to monitor and report memory access to a specified memory range.

At block 614, verification and ordering code is generated. The verification code can be code that when executed (e.g., block 618) loads a value from a read-only memory address and then compares the loaded value to a previously accessed value (e.g., accessed in block 608). The ordering code that is configured to signal a processor to order the enabling of the memory protection mechanism (e.g., during block 618) relative to a load instruction associated with the portion of memory (e.g., the memory page 420) being protected by the memory protection mechanism.

At block 616, optimized code is output. The optimized code as determined (e.g., based on blocks 604-614) is stored to memory or other storage for execution. The optimized code can include one or more range protection instructions, one or more verification instructions, one or more ordering instructions, and optimized code, e.g., with loads and other instructions replaced based on constant value propagation (e.g., block 610).

At block 618, the code is executed. The code segment generated based on the sequence of instructions (e.g., block 604), is executed. It is noted that the translation may be triggered at a first time, the optimized code output at a second time, and the code executed at a third time. The verification code may thus verify that values used in the optimizing code have not changed during the time between the output of the code (e.g., block 616) and the execution of the code.

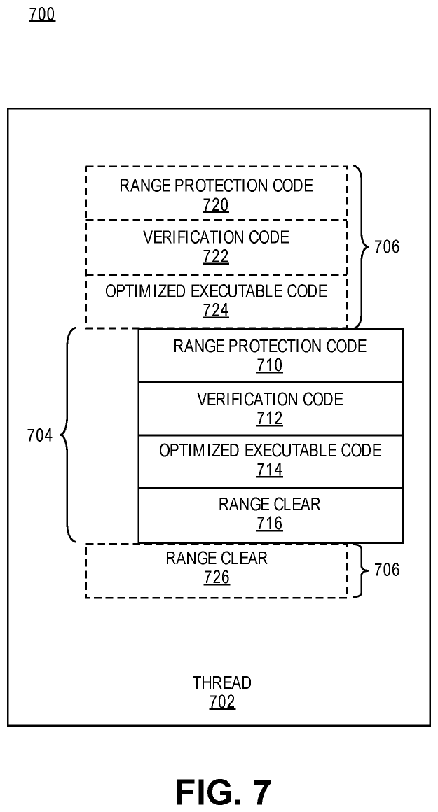

FIG. 7 shows example components of generated executable code, in accordance with various embodiments. FIG. 7 depicts example components of a portion of code (e.g., code 540) of a thread 702 (e.g., thread 202) generated by a translation process (e.g., performed by the compiler 550). The thread 702 includes code segments 704 and 706. The code segment 704 includes range protection code 710, verification code 712, optimized executable code 714, and range clear code 716. The code segment 706 includes range protection code 720, verification code 722, optimized executable code 724, and range clear code 726. In some embodiments, the code segments 704 and 706 have substantially similar portions of code including range protection code, verification code, and range clear code generated based on the respective associated executable code portions. The code segment 704 is nested within the code segment 706.

The range protection code 710 is configured to ensure that the optimized executable code 714 will execute correctly. The range protection code 710 may include one or more instructions. The range protection code 710 may include a first instruction that includes a range of addresses of memory to be protected. For example, the range of addresses may be associated with a four-kilobyte page of memory. In some embodiments, the range protection code 710 signals a hardware mechanism (e.g., memory protection monitoring module 562) to monitor access to a specified memory range.

The range protection code 710 in conjunction with range clear code 716 (or range clear code 726) thus signal the processor to notify or signal the translator if there is any memory access to the protected memory range during execution of the code segment 704. It is noted that thread 702 may include more range protection code portion than shown and may further enable protection on multiple memory ranges. Embodiments may further support protection and monitoring of memory ranges that are at a subpage granularity, e.g., smaller than the size of a page.

The range protection code 710 may further include a second instruction that signals that range protection instructions are to be performed relative to each other (e.g., in order) on an out of order processor. The second instruction may thus signal a processor to activate range protection in order relative to other range protection code. For example, the range protection code 710 may include an instruction so that range protection for the range of memory specified in the range protection code 710 is enabled after the range protection associated with range protection code 720.

The verification code 712 includes one or more instructions to verify that one or more values accessed from a read-only memory region during translation are still read-only and the value accessed during the translation matches the one or more values stored in memory during execution. In some embodiments, the verification code 712 includes one or more instructions to query whether a memory page associated with a value is read-only. The verification code 712 can detect a situation where a thread queries a page that is read-only, change an access property of the read-only page to read/write, modifies data in the memory page (e.g., a self-modifying program), and changes the property of the page back to read-only based on verifying the value of the memory pages matches the value accessed during translation.

The verification code 712 thus checks if the value is the same and if the value is not the same an exception is thrown. The exception is sent to the translator (e.g., compiler) which then can invalidate the optimized code 714. The translator may then reoptimize the code and execute the code or execute unoptimized code. If the value accessed from memory matches the value accessed by the translator, execution can proceed to the optimized executable code 714.

In some embodiments, the verification code is ordered relative to the range protection code 710 (e.g., a special load instruction executes after the range protection 710 is enabled) on a processor configured for out of order execution.

The optimized executable code 714 is code that has had one or more values from read-only memory inlined and the one or more values propagated to replace instructions, as described herein. Portions of optimized executable code 714 that do not access the protected read-only memory range can be executed out of order. The optimized executable code 704 can be executed as long as there is not an exception caused by access to a read-only memory range for which range protection has been enabled.

The range clear code 716 deactivates range protection for a memory address range. The range clear code 716 may include one or more instructions to signal a processor to deactivate range protection for a specified memory address range. In some embodiments, the range clear code 716 is optional and the range clear code 726 signals the processor to clear each enabled range protection mechanism (e.g., enable by range protection code 720 and range protection code 710). In order words, the processor may deactivate range protection for the previously specified memory ranges. In some embodiments, there is a linear ordering between range protect code and range (protection) clearing code.

In some embodiments, where a single threaded processor is used, the monitoring of external memory traffic as enabled by the range protection code may not be used while the verification code is used.

FIG. 8A shows a flowchart of an example electronic component controlled process for enabling range protection, in accordance with various embodiments. FIG. 8A depicts a flowchart 800 of blocks performed by range protection code (e.g., range protection code 710).

At block 802, range protection for a memory address range is enabled. As described herein, range protection code may include one or more instructions that signal (e.g., to a hardware component) to monitor memory traffic or access to an indicated memory address range (e.g., memory page or range of addresses) and notify a translator of access to the indicated memory range.

At block 804, ordering of range protection code relative to each other is signaled. As described herein, range protection code can signal (e.g., a hardware component) that multiple pieces of range protection code are to be executed in order, e.g., on a processor configured for out of order execution.

FIG. 8B shows a flowchart of an example electronic component controlled process for performing verification, in accordance with various embodiments. FIG. 8B depicts blocks performed by verification code (e.g., verification code 712) and blocks performed after range protection has been enabled for a memory address range. For example, the blocks 852-854 may be performed based on verification code (e.g., the verification code 712) of a thread. The blocks 860-862 may be performed by a translator (e.g., the compiler 550) and the blocks 870-872 may be performed by a component monitoring memory access (e.g., the processor 560) as enabled by range protection code (e.g., range protection code 710).

At block 852, whether memory associated with range protection is read-only memory is verified. In some embodiments, the block 852 is performed by querying a processor or memory controller with a request as to whether an indicated memory range is read-only. If the memory range associated with range protection is read-only, block 854 is performed. If the memory range associated with range protection is not read-only (e.g., read/write), block 860 is performed.

At block 854, whether one or more values within the memory (e.g., read-only) match one or more values previously accessed (e.g., as part of translation) is verified. In some embodiments, the verification of a value is performed using a specialized load instruction that is ordered relative to range protection being enabled (e.g., after block 802). The data verification instruction may be executed out of order relative to other data verification instructions but executed in order relative to the range protection. If the one or more values match the one or more values previously accessed, block 856 is performed to execution the code. If the one or more values do not match the one or more values previously accessed, block 856 is not performed and instead block 860 is performed causing an exception to be thrown.

At block 856, optimized code is executed. The optimized code can be code that has been optimized with load instructions associated with read-only memory replaced and one or more values from the read-only memory propagated to produce the optimized code.

At block 860, an exception is thrown. The exception may be thrown or output by a portion of code of a thread based on verification of a memory range not being read-only (e.g., block 852) or upon data values from memory not matching data values previously accessed during generation of the optimized code (e.g., block 854). The exception may also be thrown based on external memory traffic or a watchpoint for a protected memory range (e.g., block 870) or a write to a protected memory range (e.g., block 872).

At block 862, code is invalidated. In some embodiments, a translator (e.g., compiler 550) invalidates optimized code, replaces it with the unoptimized code, and invokes execution of the unoptimized code. The translator may also reoptimize the code unoptimized code and execute the reoptimized code.

At block 870, external memory traffic or a watchpoint set for a protected memory range is monitored. The external memory traffic to a protected memory range may include a processor core, an external device, or another thread requesting access to the protected memory. The watchpoint may be set by a debugger for an address within the protected memory range. For example, the watchpoint may be a memory address, within the protected memory range, set within a watchpoint register of a processor. The monitoring of watchpoints allows embodiments to support debuggers.

At block 872, whether there has been a write to a protected memory range is determined. If there has been a write to a protected memory range, block 860 is performed. If there was not a write to a protected memory range, block 870 is performed. The blocks 870-872 may be performed by a processor (e.g., the processor 560) monitoring a protected memory range.

Table I shows example features associated with various operating environments.

TABLE I
Example features and associated environments

| | Out of | | Debug | Single | |
|---|---|---|---|---|---|
| | order | In order | Profiling | threaded | Multi-thread |
| Features | processor | processor | support | processor | processor |
| Range Protect | | | X | | |
| Watchpoint Counter | | | | | |
| Support | | | | | |
| Range protect external | | | | | X |
| memory support | | | | | |
| Range protect ordering | X | | | | |
| Load ordering relative | X | | | | |
| to range protection | | | | | |
| Read-only verification | X | X | | X | X |
| Data verification | X | X | | X | X |

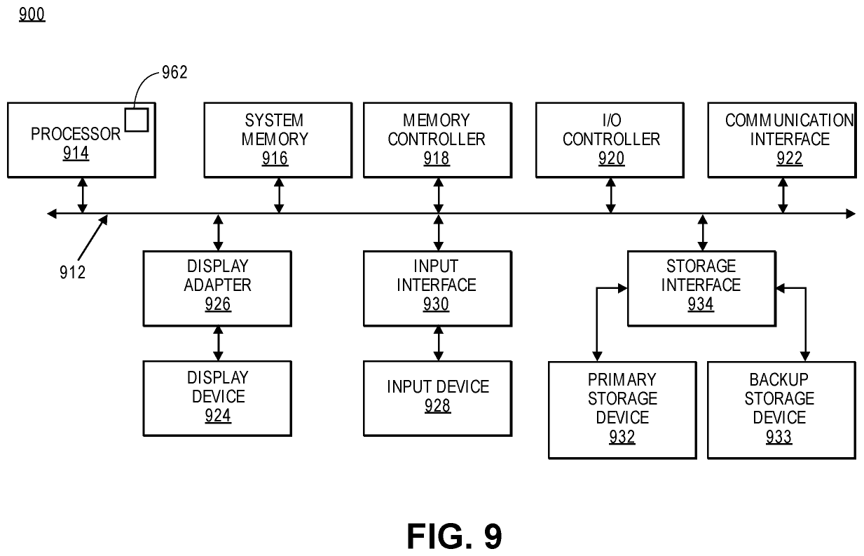

FIG. 9 is a block diagram of an example computing system 900 including various embodiments. Computing system 900 broadly represents any single or multiprocessor computing device or system capable of executing computer-readable instructions. Examples of computing system 900 include, without limitation, workstations, laptops, client-side terminals, servers, supercomputers, distributed computing systems, handheld devices, or any other computing system or device. In its most basic configuration, computing system 900 may include at least one processor 914 and a system memory 916.

Processor 914 generally represents any type or form of processing unit capable of processing data or interpreting and executing instructions. In certain embodiments, processor 914 may receive instructions from a software application or module. These instructions may cause processor 914 to perform the functions of one or more of the example embodiments described and/or illustrated herein. For example, processor 914 may perform and/or be a means for performing, either alone or in combination with other elements, one or more of the identifying, determining, using, implementing, translating, tracking, receiving, moving, and providing described herein. Processor 914 may also perform and/or be a means for performing any other steps, methods, or processes described and/or illustrated herein. The processor 914 may include functionality 962, as described herein, including memory protection monitoring module 562 and ordering module 564.

System memory 916 generally represents any type or form of volatile or nonvolatile storage device or medium capable of storing data and/or other computer-readable instructions. Examples of system memory 916 include, without limitation, RAM, ROM, FLASH memory, or any other suitable memory device. Although not required, in certain embodiments computing system 900 may include both a volatile memory unit (such as, for example, system memory 916) and a non-volatile storage device (such as, for example, primary storage device 932).

Computing system 900 may also include one or more components or elements in addition to processor 914 and system memory 916. For example, in the embodiment of FIG. 9, computing system 900 includes a memory controller 918, an I/O controller 920, and a communication interface 922, each of which may be interconnected via a communication infrastructure 912.

Communication infrastructure 912 generally represents any type or form of infrastructure capable of facilitating communication between one or more components of a computing device. Examples of communication infrastructure 912 include, without limitation, a communication bus (such as an ISA, PCI, PCIe, or similar bus) and a network. In one embodiment, system memory 916 communicates via a dedicated memory bus.

Memory controller 918 generally represents any type or form of device capable of handling memory or data or controlling communication between one or more components of computing system 900. For example, memory controller 918 may control communication between processor 914, system memory 916, and I/O controller 920 via communication infrastructure 912. Memory controller may perform and/or be a means for performing, either alone or in combination with other elements, one or more of the operations or features described herein.

I/O controller 920 generally represents any type or form of module capable of coordinating and/or controlling the input and output functions of a computing device. For example, I/O controller 920 may control or facilitate transfer of data between one or more elements of computing system 900, such as processor 914, system memory 916, communication interface 922, display adapter 926, input interface 930, and storage interface 934. I/O controller 920 may be used, for example, to perform and/or be a means for performing, either alone or in combination with other elements, one or more of the operations described herein. I/O controller 920 may also be used to perform and/or be a means for performing other operations and features set forth in the instant disclosure.

Communication interface 922 broadly represents any type or form of communication device or adapter capable of facilitating communication between example computing system 900 and one or more additional devices. For example, communication interface 922 may facilitate communication between computing system 900 and a private or public network including additional computing systems. Examples of communication interface 922 include, without limitation, a wired network interface (such as a network interface card), a wireless network interface (such as a wireless network interface card), a modem, and any other suitable interface. In one embodiment, communication interface 922 provides a direct connection to a remote server via a direct link to a network, such as the Internet. Communication interface 922 may also indirectly provide such a connection through, for example, a local area network (such as an Ethernet network), a personal area network, a telephone or cable network, a cellular telephone connection, a satellite data connection, or any other suitable connection.

Communication interface 922 may also represent a host adapter configured to facilitate communication between computing system 900 and one or more additional network or storage devices via an external bus or communications channel. Examples of host adapters include, without limitation, SCSI host adapters, USB host adapters, IEEE (Institute of Electrical and Electronics Engineers) 994 host adapters, Serial Advanced Technology Attachment (SATA) and External SATA (eSATA) host adapters, Advanced Technology Attachment (ATA) and Parallel ATA (PATA) host adapters, Fibre Channel interface adapters, Ethernet adapters, or the like. Communication interface 922 may also allow computing system 900 to engage in distributed or remote computing. For example, communication interface 922 may receive instructions from a remote device or send instructions to a remote device for execution. Communication interface 922 may perform and/or be a means for performing, either alone or in combination with other elements, one or more of the operations disclosed herein. Communication interface 922 may also be used to perform and/or be a means for performing other operations and features set forth in the instant disclosure.

As illustrated in FIG. 9, computing system 900 may also include at least one display device 924 coupled to communication infrastructure 912 via a display adapter 926. Display device 924 generally represents any type or form of device capable of visually displaying information forwarded by display adapter 926. Similarly, display adapter 926 generally represents any type or form of device configured to forward graphics, text, and other data from communication infrastructure 912 (or from a frame buffer, as known in the art) for display on display device 924.

As illustrated in FIG. 9, computing system 900 may also include at least one input device 928 coupled to communication infrastructure 912 via an input interface 930. Input device 928 generally represents any type or form of input device capable of providing input, either computer- or human-generated, to computing system 900. Examples of input device 928 include, without limitation, a keyboard, a pointing device, a speech recognition device, or any other input device. In one embodiment, input device 928 may perform and/or be a means for performing, either alone or in combination with other elements, one or more of the operations disclosed herein. Input device 928 may also be used to perform and/or be a means for performing other operations and features set forth in the instant disclosure.

As illustrated in FIG. 9, computing system 900 may also include a primary storage device 932 and a backup storage device 933 coupled to communication infrastructure 912 via a storage interface 934. Storage devices 932 and 933 generally represent any type or form of storage device or medium capable of storing data and/or other computer-readable instructions. For example, storage devices 932 and 933 may be a magnetic disk drive (e.g., a so-called hard drive), a solid state disk, a floppy disk drive, a magnetic tape drive, an optical disk drive, a FLASH drive, or the like. Storage interface 934 generally represents any type or form of interface or device for transferring data between storage devices 932 and 933 and other components of computing system 900.

Continuing with reference to FIG. 9, storage devices 932 and 933 may be configured to read from and/or write to a removable storage unit configured to store computer software, data, or other computer-readable information. Examples of suitable removable storage units include, without limitation, a floppy disk, a magnetic tape, an optical disk, a FLASH memory device, or the like. Storage devices 932 and 933 may also include other similar structures or devices for allowing computer software, data, or other computer-readable instructions to be loaded into computing system 900. For example, storage devices 932 and 933 may be configured to read and write software, data, or other computer-readable information. Storage devices 932 and 933 may also be a part of computing system 900 or may be separate devices accessed through other interface systems.

Storage devices 932 and 933 may be used to perform, and/or be a means for performing, either alone or in combination with other elements, one or more of the operations disclosed herein. Storage devices 932 and 933 may also be used to perform, and/or be a means for performing, other operations and features set forth in the instant disclosure.

Many other devices or subsystems may be connected to computing system 900. Conversely, all of the components and devices illustrated in FIG. 9 need not be present to practice the embodiments described herein. The devices and subsystems referenced above may also be interconnected in different ways from that shown in FIG. 9. Computing system 900 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into computing system 900. All or a portion of the computer program stored on the computer-readable medium may then be stored in system memory 916 and/or various portions of storage devices 932 and 933. When executed by processor 914, a computer program loaded into computing system 900 may cause processor 914 to perform and/or be a means for performing the functions of the example embodiments described and/or illustrated herein. Additionally or alternatively, the example embodiments described and/or illustrated herein may be implemented in firmware and/or hardware. For example, computing system 900 may be configured as an ASIC adapted to implement one or more of the embodiments disclosed herein. While the embodiments described in relation to FIG. 9 provide an example computer system 900 architecture. The following sections provide a description of additional detailed example architectures, processors and systems in which the embodiments may be implemented.

### Example Implementations

In one example embodiment, a processor includes at least one core having circuitry to execute instructions in native code and a translator to convert guest code to native code, and a memory protection circuit coupled to the at least one core. The memory protection circuit monitors access to an indicated memory address range in the native code associated with a read-only portion of the memory and detects access to the indicated memory address range. The memory protection circuit raises an exception in response to memory access to the indicated memory address range, and determines an access property of the indicated memory address range. In some embodiments, the memory protection circuit is further configured to raise the exception in response to detecting a watchpoint associated with a memory address within the indicated memory address range. The watchpoint may be associated with the memory address that is stored in a watchpoint register. The processor can have at least one core that is configured for multi-threaded execution. The at least one core may also be configured for out of order execution. The processor may also include an ordering circuit coupled to the at least one core, where the ordering circuit orders a load instruction relative to the enabling of monitoring of the indicated memory address range associated with the read-only portion of the memory. The at least one core can also be configured to execute the load instruction to verify a value within the indicated memory range with a value previously accessed within the indicated memory range.

In another example embodiment, a computer implements the method for translating guest code to native code for a processor of the computer system. The computer system accesses a plurality of instructions, determines whether a first instruction of the plurality of instructions accesses a read-only portion of a memory, and in response to determining that the first instruction of the plurality of instructions accesses the read-only portion of the memory, accesses a value associated with the first instruction. The computer further modifies the first instruction based on the value associated with the first instruction, sends a memory range associated with the read-only portion of the memory to the processor to enable an exception throw if the memory range is accessed, and stores the plurality of instructions. The computer implemented method further modifies a second instruction based on the value associated with the first instruction. The computer implemented method further propagates the value associated with the first instruction through the plurality of instructions. The computer implemented method can query the processor to determine if the memory range is read-only. The computer implemented method can add a second instruction to the plurality of instructions, wherein the second instruction is configured to verify the value associated the read-only portion of memory during execution. The computer implemented method can add a second instruction to the plurality of instructions, wherein the second instruction is configured to enable monitoring of the memory range associated with read-only portion of the memory during execution. In addition, the computer implemented method can add a third instruction to the plurality of instructions, wherein the third instruction is configured to order a load instruction relative to the second instruction during execution.

In another embodiment, a non-transitory computer readable storage medium has stored thereon computer executable instructions that, if executed by a computer system cause the computer system to perform a set of operations to provide code translation, the set of operations accesses a plurality of instructions, determine whether a first instruction of the plurality of instructions accesses a read-only portion of a memory, and in response to determining that the first instruction of the plurality of instructions accesses the read-only portion of the memory, accessing a value associated with the first instruction. The operations further modify the first instruction based on the value associated with the first instruction, receive notification from a processor that a memory range associated with the read-only portion of the memory has been accessed, and reverse the modification of the first instruction in response to the notification. The operations further include modifying a second instruction based on the value associated with the first instruction and propagating the value associated with the first instruction through the plurality of instructions. In some embodiments, the operations include sending the memory range associated with the read-only portion of the memory to the processor to enable monitoring of accesses to the memory range. The operations may also include adding a second instruction to the plurality of instructions, wherein the second instruction is configured to verify the value associated the read-only portion of memory during execution and adding a second instruction to the plurality of instructions, wherein the second instruction is configured to enable monitoring of the memory range associated with read-only portion of the memory during execution.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Example core architectures are described next, followed by descriptions of example processors and computer architectures.

### Example Core Architectures

### In-Order and Out-of-Order Core Block Diagram

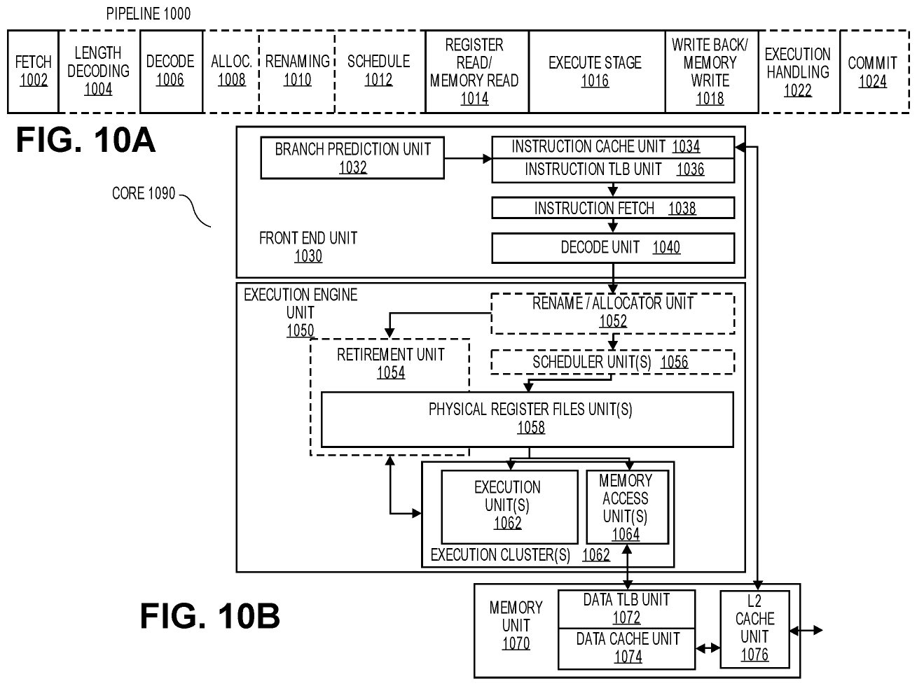

FIG. 10A is a block diagram illustrating both an example in-order pipeline and an example register renaming, out-of-order issue/execution pipeline according to embodiments of the disclosure. FIG. 10B is a block diagram illustrating both an example embodiment of an in-order architecture core and an example register renaming, out-of-order issue/execution architecture core to be included in a processor according to embodiments of the disclosure. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, a length decode stage 1004, a decode stage 1006, an allocation stage 1008, a renaming stage 1010, a scheduling (also known as a dispatch or issue) stage 1012, a register read/memory read stage 1014, an execute stage 1016, a write back/memory write stage 1018, an exception handling stage 1022, and a commit stage 1024.

FIG. 10B shows processor core 1090 including a front end unit 1030 coupled to an execution engine unit 1050, and both are coupled to a memory unit 1070. The core 1090 may be a reduced instruction set computing (RISC) core, a complex instruction set computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit 1030 includes a branch prediction unit 1032 coupled to an instruction cache unit 1034, which is coupled to an instruction translation lookaside buffer (TLB) 1036, which is coupled to an instruction fetch unit 1038, which is coupled to a decode unit 1040. The decode unit 1040 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 1040 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1090 includes a microcode ROM or other medium that stores microcode for certain macroinstructions (e.g., in decode unit 1040 or otherwise within the front end unit 1030). The decode unit 1040 is coupled to a rename/allocator unit 1052 in the execution engine unit 1050.

The execution engine unit 1050 includes the rename/allocator unit 1052 coupled to a retirement unit 1054 and a set of one or more scheduler unit(s) 1056. The scheduler unit(s) 1056 represents any number of different schedulers, including reservations stations, central instruction window, etc. The scheduler unit(s) 1056 is coupled to the physical register file(s) unit(s) 1058. Each of the physical register file(s) units 1058 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1058 comprises a vector registers unit, a write mask registers unit, and a scalar registers unit. These register units may provide architectural vector registers, vector mask registers, and general purpose registers. The physical register file(s) unit(s) 1058 is overlapped by the retirement unit 1054 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1054 and the physical register file(s) unit(s) 1058 are coupled to the execution cluster(s) 1060. The execution cluster(s) 1060 includes a set of one or more execution units 1062 and a set of one or more memory access units 1064. The execution units 1062 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1056, physical register file(s) unit(s) 1058, and execution cluster(s) 1060 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1064). It should also be understood that where separate pipelines are used, one or more of these pipelines may be out-of-order issue/execution and the rest in-order.

The set of memory access units 1064 is coupled to the memory unit 1070, which includes a data TLB unit 1072 coupled to a data cache unit 1074 coupled to a level 2 (L2) cache unit 1076. In one example embodiment, the memory access units 1064 may include a load unit, a store address unit, and a store data unit, each of which is coupled to the data TLB unit 1072 in the memory unit 1070. The instruction cache unit 1034 is further coupled to a level 2 (L2) cache unit 1076 in the memory unit 1070. The L2 cache unit 1076 is coupled to one or more other levels of cache and eventually to a main memory.

By way of example, the example register renaming, out-of-order issue/execution core architecture may implement the pipeline 1000 as follows: 1) the instruction fetch 1038 performs the fetch and length decoding stages 1002 and 1004; 2) the decode unit 1040 performs the decode stage 1006; 3) the rename/allocator unit 1052 performs the allocation stage 1008 and renaming stage 1010; 4) the scheduler unit(s) 1056 performs the schedule stage 1012; 5) the physical register file(s) unit(s) 1058 and the memory unit 1070 perform the register read/memory read stage 1014; the execution cluster 1060 perform the execute stage 1016; 6) the memory unit 1070 and the physical register file(s) unit(s) 1058 perform the write back/memory write stage 1018; 7) various units may be involved in the exception handling stage 1022; and 8) the retirement unit 1054 and the physical register file(s) unit(s) 1058 perform the commit stage 1024.

The core 1090 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1090 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1034/1074 and a shared L2 cache unit 1076, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Example In-Order Core Architecture

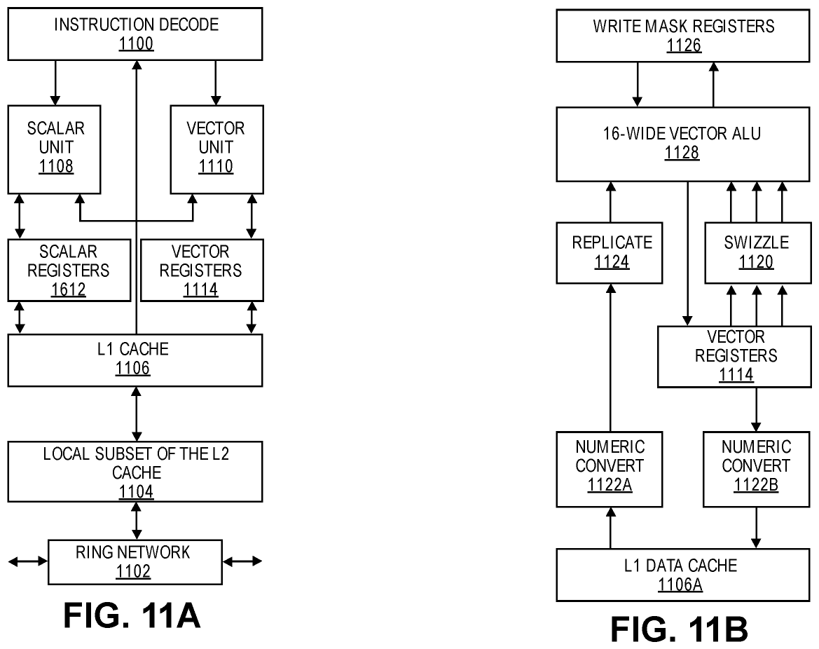

FIGS. 11A-B illustrate a block diagram of a more specific example in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 11A is a block diagram of a single processor core, along with its connection to the on-die interconnect network 1102 and with its local subset of the Level 2 (L2) cache 1104, according to embodiments of the disclosure. In one embodiment, an instruction decode unit 1100 supports the x86 instruction set with a packed data instruction set extension. An L1 cache 1106 allows low-latency accesses to cache memory into the scalar and vector units. While in one embodiment (to simplify the design), a scalar unit 1108 and a vector unit 1110 use separate register sets (respectively, scalar registers 1112 and vector registers 1114) and data transferred between them is written to memory and then read back in from a level 1 (L1) cache 1106, alternative embodiments of the disclosure may use a different approach (e.g., use a single register set or include a communication path that allow data to be transferred between the two register files without being written and read back).

The local subset of the L2 cache 1104 is part of a global L2 cache that is divided into separate local subsets, one per processor core. Each processor core has a direct access path to its own local subset of the L2 cache 1104. Data read by a processor core is stored in its L2 cache subset 1104 and can be accessed quickly, in parallel with other processor cores accessing their own local L2 cache subsets. Data written by a processor core is stored in its own L2 cache subset 1104 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 11B is an expanded view of part of the processor core in FIG. 11A according to embodiments of the disclosure. FIG. 11B includes an L1 data cache 1106A part of the L1 cache 1104, as well as more detail regarding the vector unit 1110 and the vector registers 1114. Specifically, the vector unit 1110 is a 16-wide vector processing unit (VPU) (see the 16-wide ALU 1128), which executes one or more of integer, single-precision float, and double-precision float instructions. The VPU supports swizzling the register inputs with swizzle unit 1120, numeric conversion with numeric convert units 1122A-B, and replication with replication unit 1124 on the memory input. Write mask registers 1126 allow predicating resulting vector writes.

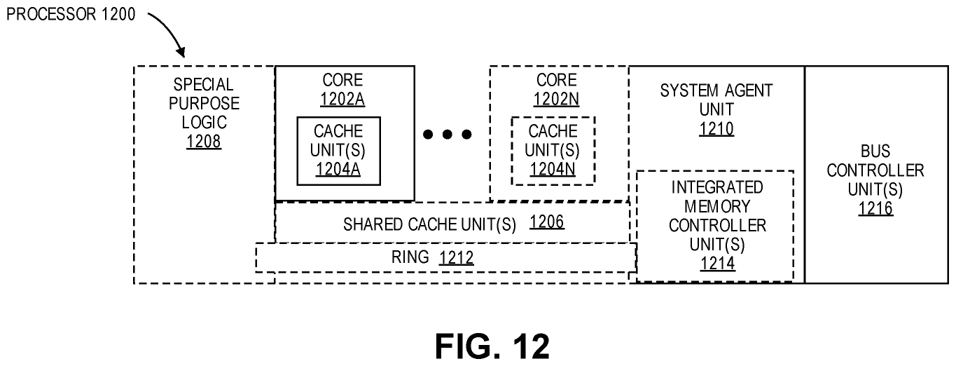

FIG. 12 is a block diagram of a processor 1200 that may have more than one core, may have an integrated memory controller, and may have integrated graphics according to embodiments of the disclosure. The solid lined boxes in FIG. 12 illustrate a processor 1200 with a single core 1202A, a system agent 1210, a set of one or more bus controller units 1216, while the optional addition of the dashed lined boxes illustrates an alternative processor 1200 with multiple cores 1202A-N, a set of one or more integrated memory controller unit(s) 1214 in the system agent unit 1210, and special purpose logic 1208.

Thus, different implementations of the processor 1200 may include: 1) a CPU with the special purpose logic 1208 being integrated graphics and/or scientific (throughput) logic (which may include one or more cores), and the cores 1202A-N being one or more general purpose cores (e.g., general purpose in-order cores, general purpose out-of-order cores, a combination of the two); 2) a coprocessor with the cores 1202A-N being a large number of special purpose cores intended primarily for graphics and/or scientific (throughput); and 3) a coprocessor with the cores 1202A-N being a large number of general purpose in-order cores. Thus, the processor 1200 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1200 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1206, and external memory (not shown) coupled to the set of integrated memory controller units 1214. The set of shared cache units 1206 may include one or more mid-level caches, such as level 2 (L2), level 3 (L3), level 4 (L4), or other levels of cache, a last level cache (LLC), and/or combinations thereof. While in one embodiment a ring based interconnect unit 1212 interconnects the integrated graphics logic 1208, the set of shared cache units 1206, and the system agent unit 1210/integrated memory controller unit(s) 1214, alternative embodiments may use any number of well-known techniques for interconnecting such units. In one embodiment, coherency is maintained between one or more cache units 1206 and cores 1202-A-N.

In some embodiments, one or more of the cores 1202A-N are capable of multi-threading. The system agent 1210 includes those components coordinating and operating cores 1202A-N. The system agent unit 1210 may include for example a power control unit (PCU) and a display unit. The PCU may be or include logic and components needed for regulating the power state of the cores 1202A-N and the integrated graphics logic 1208. The display unit is for driving one or more externally connected displays.

The cores 1202A-N may be homogenous or heterogeneous in terms of architecture instruction set; that is, two or more of the cores 1202A-N may be capable of execution the same instruction set, while others may be capable of executing only a subset of that instruction set or a different instruction set.

### Example Computer Architectures

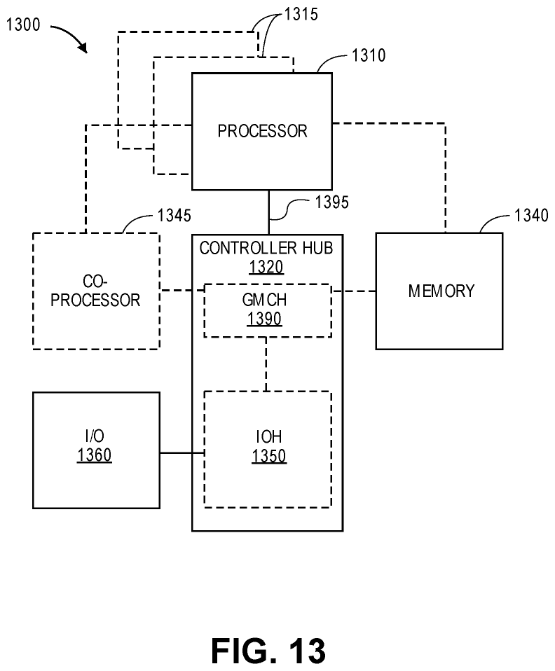

FIGS. 13-16 are block diagrams of example computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 13, shown is a block diagram of a system 1300 in accordance with one embodiment of the present disclosure. The system 1300 may include one or more processors 1310, 1315, which are coupled to a controller hub 1320. In one embodiment, the controller hub 1320 includes a graphics memory controller hub (GMCH) 1390 and an Input/Output Hub (IOH) 1350 (which may be on separate chips); the GMCH 1390 includes memory and graphics controllers to which are coupled memory 1340 and a coprocessor 1345; the IOH 1350 is couples input/output (I/O) devices 1360 to the GMCH 1390. Alternatively, one or both of the memory and graphics controllers are integrated within the processor (as described herein), the memory 1340 and the coprocessor 1345 are coupled directly to the processor 1310, and the controller hub 1320 in a single chip with the IOH 1350. Memory 1340 may include a memory refresh management module 1340A, for example, to store code that when executed causes a processor to perform any method of this disclosure.

The optional nature of additional processors 1315 is denoted in FIG. 13 with broken lines. Each processor 1310, 1315 may include one or more of the processing cores described herein and may be some version of the processor 1200.

The memory 1340 may be, for example, dynamic random access memory (DRAM), phase change memory (PCM), or a combination of the two. For at least one embodiment, the controller hub 1320 communicates with the processor(s) 1310, 1315 via a multi-drop bus, such as a frontside bus (FSB), point-to-point interface such as QuickPath Interconnect (QPI), or similar connection 1395.

In one embodiment, the coprocessor 1345 is a special-purpose processor, such as, for example, a high-throughput MIC processor, a network or communication processor, compression engine, graphics processor, GPGPU, embedded processor, or the like. In one embodiment, controller hub 1320 may include an integrated graphics accelerator.

There can be a variety of differences between the physical resources 1310, 1315 in terms of a spectrum of metrics of merit including architectural, microarchitectural, thermal, power consumption characteristics, and the like.

In one embodiment, the processor 1310 executes instructions that control data processing operations of a general type. Embedded within the instructions may be coprocessor instructions. The processor 1310 recognizes these coprocessor instructions as being of a type that should be executed by the attached coprocessor 1345. Accordingly, the processor 1310 issues these coprocessor instructions (or control signals representing coprocessor instructions) on a coprocessor bus or other interconnect, to coprocessor 1345. Coprocessor(s) 1345 accept and execute the received coprocessor instructions.

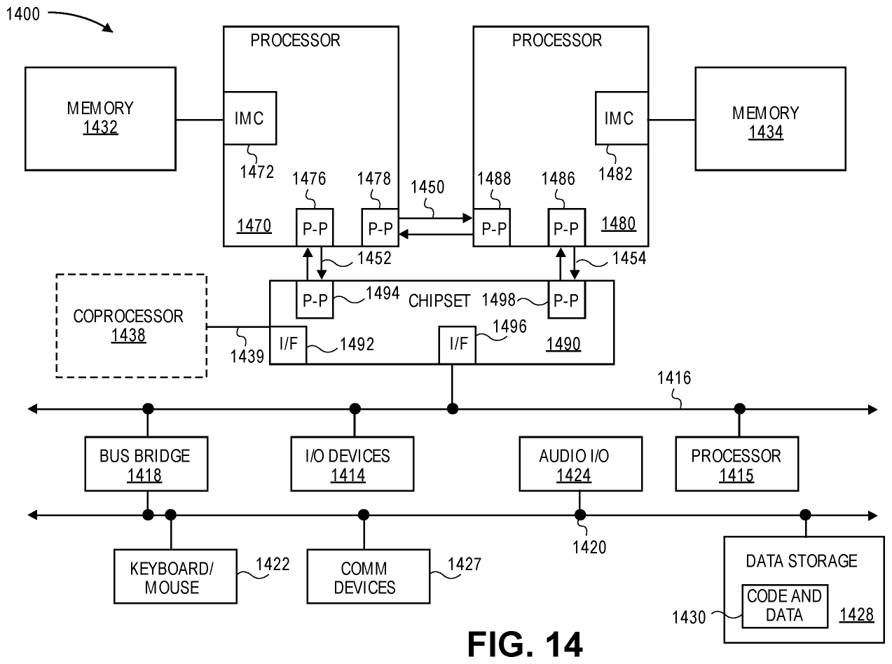

Referring now to FIG. 14, shown is a block diagram of a first more specific example system 1400 in accordance with an embodiment of the present disclosure. As shown in FIG. 14, multiprocessor system 1400 is a point-to-point interconnect system, and includes a first processor 1470 and a second processor 1480 coupled via a point-to-point interconnect 1450. Each of processors 1470 and 1480 may be some version of the processor 1200. In one embodiment of the disclosure, processors 1470 and 1480 are respectively processors 1310 and 1315, while coprocessor 1438 is coprocessor 1345. In another embodiment, processors 1470 and 1480 are respectively processor 1310 coprocessor 1345.

Processors 1470 and 1480 are shown including integrated memory controller (IMC) units 1472 and 1482, respectively. Processor 1470 also includes as part of its bus controller units point-to-point (P-P) interfaces 1476 and 1478; similarly, second processor 1480 includes P-P interfaces 1486 and 1488. Processors 1470, 1480 may exchange information via a point-to-point (P-P) interface 1450 using P-P interface circuits 1478, 1488. As shown in FIG. 14, IMCs 1472 and 1482 couple the processors to respective memories, namely a memory 1432 and a memory 1434, which may be portions of main memory locally attached to the respective processors.

Processors 1470, 1480 may each exchange information with a chipset 1490 via individual P-P interfaces 1452, 1454 using point to point interface circuits 1476, 1494, 1486, 1498. Chipset 1490 may optionally exchange information with the coprocessor 1438 via a high-performance interface 1439. In one embodiment, the coprocessor 1438 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of the present disclosure is not so limited.

As shown in FIG. 14, various I/O devices 1414 may be coupled to first bus 1416, along with a bus bridge 1418 which couples first bus 1416 to a second bus 1420. In one embodiment, one or more additional processor(s) 1415, such as coprocessors, high-throughput MIC processors, GPGPU's, accelerators (such as, e.g., graphics accelerators or digital signal processing (DSP) units), field programmable gate arrays, or any other processor, are coupled to first bus 1416. In one embodiment, second bus 1420 may be a low pin count (LPC) bus. Various devices may be coupled to a second bus 1420 including, for example, a keyboard and/or mouse 1422, communication devices 1427 and a storage unit 1428 such as a disk drive or other mass storage device which may include instructions/code and data 1430, in one embodiment. Further, an audio I/O 1424 may be coupled to the second bus 1420. Note that other architectures are possible. For example, instead of the point-to-point architecture of FIG. 14, a system may implement a multi-drop bus or other such architecture.

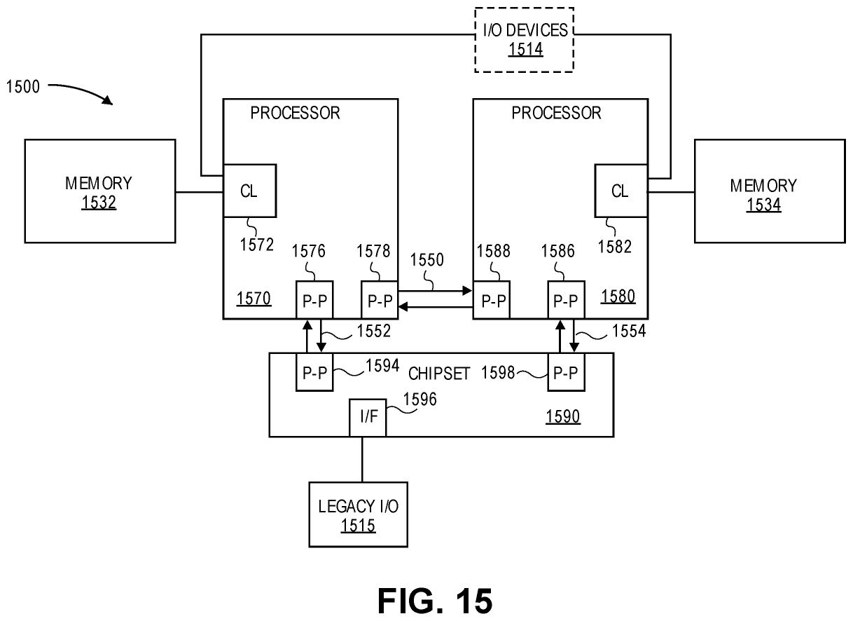

Referring now to FIG. 15, shown is a block diagram of a second more specific example system 1500 in accordance with an embodiment of the present disclosure. Like elements in FIGS. 14 and 15 bear like reference numerals, and certain aspects of FIG. 14 have been omitted from FIG. 15 in order to avoid obscuring other aspects of FIG. 15.

FIG. 15 illustrates that the processors 1470, 1480 may include integrated memory and I/O control logic (“CL”) 1472 and 1482, respectively. Thus, the CL 1472, 1482 include integrated memory controller units and include I/O control logic. FIG. 15 illustrates that not only are the memories 1432, 1434 coupled to the CL 1472, 1482, but also that I/O devices 1514 are also coupled to the control logic 1472, 1482. Legacy I/O devices 1515 are coupled to the chipset 1490.

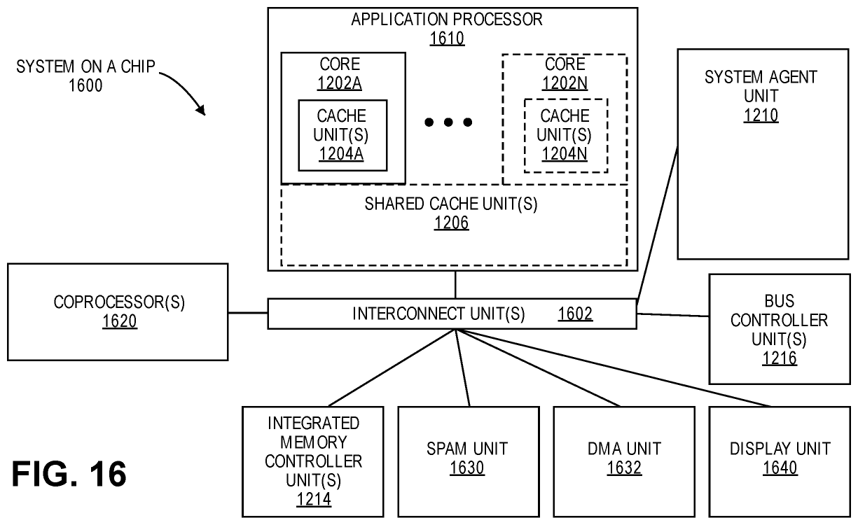

Referring now to FIG. 16, shown is a block diagram of a SoC 1600 in accordance with an embodiment of the present disclosure. Similar elements in FIG. 12 bear like reference numerals. Also, dashed lined boxes are optional features on more advanced SoCs. In FIG. 16, an interconnect unit(s) 1602 is coupled to: an application processor 1610 which includes a set of one or more cores 202A-N and shared cache unit(s) 1206; a system agent unit 1210; a bus controller unit(s) 1216; an integrated memory controller unit(s) 1214; a set or one or more coprocessors 1620 which may include integrated graphics logic, an image processor, an audio processor, and a video processor; an static random access memory (SRAM) unit 1630; a direct memory access (DMA) unit 1632; and a display unit 1640 for coupling to one or more external displays. In one embodiment, the coprocessor(s) 1620 include a special-purpose processor, such as, for example, a network or communication processor, compression engine, GPGPU, a high-throughput MIC processor, embedded processor, or the like.

Embodiments (e.g., of the mechanisms) disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1430 illustrated in FIG. 14, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

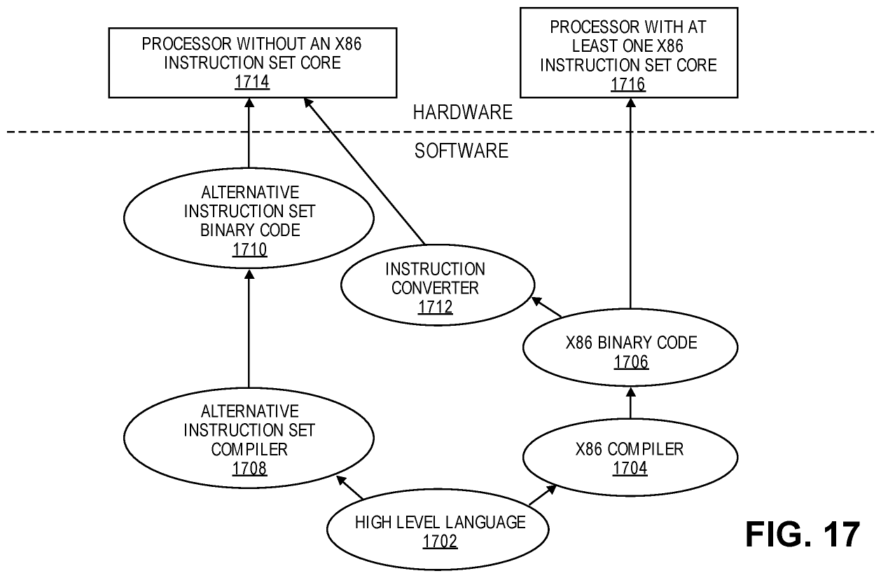

FIG. 17 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 17 shows a program in a high level language 1702 may be compiled using an x86 compiler 1704 to generate x86 binary code 1706 that may be natively executed by a processor with at least one x86 instruction set core 1716. The processor with at least one x86 instruction set core 1716 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1704 represents a compiler that is operable to generate x86 binary code 1706 (e.g., object code) that can, with or without additional linkage processing, be executed on the processor with at least one x86 instruction set core 1716. Similarly, FIG. 17 shows the program in the high level language 1702 may be compiled using an alternative instruction set compiler 1708 to generate alternative instruction set binary code 1710 that may be natively executed by a processor without at least one x86 instruction set core 1714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1712 is used to convert the x86 binary code 1706 into code that may be natively executed by the processor without an x86 instruction set core 1714. This converted code is not likely to be the same as the alternative instruction set binary code 1710 because an instruction converter capable of this is difficult to make; however, the converted code will accomplish the general operation and be made up of instructions from the alternative instruction set. Thus, the instruction converter 1712 represents software, firmware, hardware, or a combination thereof that, through emulation, simulation or any other process, allows a processor or other electronic device that does not have an x86 instruction set processor or core to execute the x86 binary code 1706.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as may be suited to the particular use contemplated.

Embodiments according to the present disclosure are thus described. While the present disclosure has been described in particular embodiments, it should be appreciated that the disclosure should not be construed as limited by such embodiments, but rather construed according to the below claims.

1. A processor comprising:
at least one core having circuitry to execute instructions in native code and a translator to convert guest code to native code; and
a memory protection circuit coupled to the at least one core, the memory protection circuit to monitor access to an indicated memory address range in the native code associated with a read-only portion of the memory and to detect access to the indicated memory address range, to raise an exception in response to memory access to the indicated memory address range, and to determine an access property of the indicated memory address range.

2. The processor of claim 1, wherein the memory protection circuit is further to raise the exception in response to detecting a watchpoint associated with a memory address within the indicated memory address range.

3. The processor of claim 2, wherein the watchpoint associated with the memory address is stored in a watchpoint register.

4. The processor of claim 1, wherein the at least one core is configured for multi-thread execution.

5. The processor of claim 1, wherein the at least one core is configured for out of order execution.

6. The processor of claim 5, further comprising:
an ordering circuit coupled to the at least one core, the ordering circuit to order a load instruction relative to enabling of monitoring of the indicated memory address range associated with the read-only portion of the memory.

7. The processor of claim 6, wherein the at least one core is configured to execute the load instruction to verify a value within the indicated memory range with a value previously accessed within the indicated memory range.

8. A computer implemented method for translating guest code to native code for a processor, the method comprising:
accessing a plurality of instructions;
determining whether a first instruction of the plurality of instructions accesses a read-only portion of a memory;
in response to determining that the first instruction of the plurality of instructions accesses the read-only portion of the memory, accessing a value associated with the first instruction;
modifying the first instruction based on the value associated with the first instruction;
sending a memory range associated with the read-only portion of the memory to the processor to enable an exception throw if the memory range is accessed; and
storing the plurality of instructions.

9. The computer implemented method of claim 8, further comprising:
modifying a second instruction based on the value associated with the first instruction.

10. The computer implemented method of claim 8, further comprising:
propagating the value associated with the first instruction through the plurality of instructions.

11. The computer implemented method of claim 8, further comprising:
querying the processor to determine if the memory range is read-only.

12. The computer implemented method of claim 8 further comprising:
adding a second instruction to the plurality of instructions, wherein the second instruction is configured to verify the value associated the read-only portion of memory during execution.

13. The computer implemented method of claim 8 further comprising:
adding a second instruction to the plurality of instructions, wherein the second instruction is configured to enable monitoring of the memory range associated with read-only portion of the memory during execution.

14. The computer implemented method of claim 13 further comprising:
adding a third instruction to the plurality of instructions, wherein the third instruction is configured to order a load instruction relative to the second instruction during execution.

15. A non-transitory computer readable storage medium having stored thereon, computer executable instructions that, if executed by a computer system cause the computer system to perform a set of operations to provide code translation, the set of operations comprising:
accessing a plurality of instructions;
determining whether a first instruction of the plurality of instructions accesses a read-only portion of a memory;
in response to determining that the first instruction of the plurality of instructions accesses the read-only portion of the memory, accessing a value associated with the first instruction;
modifying the first instruction based on the value associated with the first instruction;
receiving notification from a processor that a memory range associated with the read-only portion of the memory has been accessed; and
reversing the modification of the first instruction in response to the notification.

16. The non-transitory computer readable storage medium of claim 15 further comprising:
modifying a second instruction based on the value associated with the first instruction.

17. The non-transitory computer readable storage medium of claim 15 further comprising:
propagating the value associated with the first instruction through the plurality of instructions.

18. The non-transitory computer readable storage medium of claim 15, further comprising:
sending the memory range associated with the read-only portion of the memory to the processor to enable monitoring of accesses to the memory range.

19. The non-transitory computer readable storage medium of claim 15 further comprising:
adding a second instruction to the plurality of instructions, wherein the second instruction is configured to verify the value associated the read-only portion of memory during execution.

20. The non-transitory computer readable storage medium of claim 15 further comprising:
adding a second instruction to the plurality of instructions, wherein the second instruction is configured to enable monitoring of the memory range associated with read-only portion of the memory during execution.

21.-25. (canceled)
